(19) United States
(12) Patent Application Publication
(10) Pub. No.: US 2023/0281131 A1
(43) Pub. Date: Sep. 7, 2023

(54) INTERRUPT HANDLING

(71) Applicant: Arm Limited, Cambridge, (GB)

(72) Inventors: Spyridoula Vlasia Maria KOUMOUSI, Cambridge (GB); Neelima RATNAPARKHI, Cambridge (GB); Saqib RASHID, Cambridge (GB); Andrew MERRITT, Cambridge (GB); Louis Jean-Yves F. DASSY, Cambridge (GB); Alex BEHARRELL, Cambridge (GB)

(21) Appl. No.: 18/174,355

(22) Filed: Feb. 24, 2023

(30) Foreign Application Priority Data
Mar. 3, 2022 (EP) 22386009.9

(51) Int. Cl. G06F 12/0868; G06F 13/24

(52) U.S. Cl. CPC G06F 12/0868; G06F 13/24

(57) ABSTRACT

An apparatus has processing circuitry and a memory system. The memory system is responsive to a first type of memory access operation for which a time taken to handle the memory access operation is unbounded, the operation is able to change contents of data stored in the memory system, and a response is required. The apparatus has memory access operation handling circuitry that receives an indication of an interrupt to be taken while a memory access operation of the first type is being handled by the memory system and determines whether the memory access operation has reached a stage for which a remaining time to complete the memory access operation will be bounded. In dependence on the remaining time, the memory access operation handling circuitry either stalls the interrupt until the memory access operation has completed or aborts the memory access operation and allow the interrupt to be taken.

### CROSS-REFERENCE TO RELATED APPLICATIONS

This application claims priority pursuant to 35 U.S.C. 119(a) to European Application No. 22386009.9, filed Mar. 3, 2022, which application is incorporated herein by reference in its entirety.

### BACKGROUND

The present technique relates to the field of data processing. More particularly, the present technique relates to interrupt handling.

In some applications, it is important to be able to guarantee that certain operations such as the handling of interrupts will complete within a certain period of time, i.e., that the time taken to complete these operations will be bounded. In such circumstances, the ability to perform the operation with a bounded period of time may be more significant than the actual amount of time taken to complete the operation. This is often the case in safety-critical or other real-time applications where a data processing apparatus needs to be able to consistently respond to an event within a certain period of time.

### SUMMARY

In one example arrangement, there is provided an apparatus comprising: processing circuitry to execute instructions; a memory system to store data and provide access to the data in response to memory access operations from the processing circuitry, wherein the memory system is operable in response to a first type of memory access operation for which: a time taken to handle the memory access operation is unbounded, the memory access operation is able to change contents of data stored in the memory system, and a response is required from the memory system in respect of the memory access operation; and memory access operation handling circuitry responsive to receiving, when a memory access operation of the first type of memory access operation is being handled by the memory system, an indication of an interrupt to be taken, to determine whether the memory access operation has reached a stage for which a remaining time to complete the memory access operation will be bounded; wherein the memory access operation handling circuitry is responsive: to the remaining time to complete the memory access operation being bounded, to stall the interrupt until the memory access operation has completed; and to the remaining time to complete the memory access operation being unbounded, to abort the memory access operation and allow the interrupt to be taken.

In another example arrangement, there is provided a method comprising: executing instructions by processing circuitry; storing data by a memory system; providing access to the data in response to memory access operations from the processing circuitry; wherein the memory access operations comprise a first type of memory access operation for which: a time taken to handle the memory access operation is unbounded, the memory access operation is able to change contents of data stored in the memory system, and a response is required from the memory system in respect of the memory access operation; and in response to receiving, when a memory access operation of the first type of operation is being handled by the memory system, an indication of an interrupt to be taken, determining whether the memory access operation has reached a stage for which a remaining time to complete the memory access operation will be bounded; responsive to the remaining time to complete the memory access operation being bounded, stalling the interrupt until the memory access operation has completed; and responsive to the remaining time to complete the memory access operation being unbounded, aborting the memory access operation and allowing the interrupt to be taken.

In a yet further example arrangement, there is provided a non-transitory computer-readable medium to store computer-readable code for fabrication of an apparatus comprising: processing circuitry to execute instructions; a memory system to store data and provide access to the data in response to memory access operations from the processing circuitry, wherein the memory system is operable in response to a first type of memory access operation for which: a time taken to handle the memory access operation is unbounded, the memory access operation is able to change contents of data stored in the memory system, and a response is required from the memory system in respect of the memory access operation; and memory access operation handling circuitry responsive to receiving, when a memory access operation of the first type of memory access operation is being handled by the memory system, an indication of an interrupt to be taken, to determine whether the memory access operation has reached a stage for which a remaining time to complete the memory access operation will be bounded; wherein the memory access operation handling circuitry is responsive: to the remaining time to complete the memory access operation being bounded, to stall the interrupt until the memory access operation has completed; and to the remaining time to complete the memory access operation being unbounded, to abort the memory access operation and allow the interrupt to be taken.

### BRIEF DESCRIPTION OF THE DRAWINGS

Further aspects, features, and advantages of the present technique will be apparent from the following description of examples, which is to be read in conjunction with the accompanying drawings, in which:

FIG. 1 is a schematic illustrating an apparatus in which the techniques described herein may be applied;

FIG. 2 is a timing diagram showing the progression of a memory access operation as the memory access operation is handled by a memory system;

FIG. 3A depicts a write-exclusive operation as an example of the first type of memory access operation with respect to which the techniques described herein may be applied;

FIG. 3B depicts an atomic operation as an example of the first type of memory access operation with respect to which the techniques described herein may be applied;

FIG. 4 is a flowchart illustrating the operation of the apparatus in accordance with the techniques described herein;

FIG. 5A is a schematic illustrating a memory access operation being handled by a memory system operating according to a write-back arrangement;

FIG. 5B is a schematic illustrating a memory access operation being aborted in a memory system operating according to a write-back arrangement;

FIG. 6A is a schematic illustrating a memory access operation being handled by a memory system operating according to a write-through arrangement; and

FIG. 6B is a schematic illustrating a memory access operation being aborted in a memory system operating according to a write-through arrangement.

### DESCRIPTION OF EXAMPLES

Before discussing the embodiments with reference to the accompanying figures, the following description of embodiments is provided.

In an apparatus with processing circuitry to execute instructions and a memory system to store data used by the processing circuitry, particular forms of memory access operations can cause difficulties when trying to enable the processing circuitry to be able to handle interrupts in bounded time.

In general, memory access operations are any form of operation carried out by the processing circuitry which involves accessing the memory system. For example, read/load or store/write operations which involve reading data from the memory system and writing data to the memory system respectively are memory access operations.

For some memory access operations, such as load and store operations, if an interrupt is received while the memory access operation is being handled by the memory system, the interrupt can be taken straight away without causing problems with respect to the memory access operations which are “in-flight”. For a read operation, this may be because the load operation is performed speculatively such that if the load operation is aborted due to the interrupt being handled, the processing circuitry can later perform the load operation again to retrieve this data. For a store operation, once the store operation has been initiated in the memory system, a received interrupt may be able to be taken without interfering with the handling of the store operation in the memory system, with the memory system operating to store the data associated with the store operation while the processing circuitry takes the interrupt. For such memory access operations therefore, if an interrupt is received while a memory access operation is being handled by the memory system, the interrupt can be taken straight away. As long as the interrupt handling itself can be performed in bounded time once the interrupt has been taken, the interrupt can be handled overall within bounded time.

However, for particular forms of memory access operation, referred to herein as memory access operations of a first type, techniques which may be suitable for handling interrupts while other forms of memory access operation are in-flight are not suitable. For memory access operations of the first type, the time taken to handle the memory access operation is unbounded such that the memory access operations are not guaranteed to complete within any particular amount of time. The memory access operations of the first type are also able to change the contents of data stored in the memory system. In some cases, whether the memory access operation changes the contents of data in the memory system is contingent. In such cases, whether the change to the contents of data is carried out is dependent on, for example, data already stored in the memory system or whether a data item to be modified is indicated as being for exclusive access by the processing circuitry from which the memory access operation of the first type originated. Additionally, for memory access operations of the first type, a response is required from the memory system in respect of the memory access operation. As used herein, the requirement of a response from the memory system is a property of how the memory access operation and its behaviour is specified. The response may for example involve a confirmation to indicate whether the memory access operation of the first type was carried out successfully or may include data read from the memory system. Where the response is a confirmation, the confirmation can be explicit, or implicit. For example, the data read may implicitly indicate success if it is known that the operation would only take place if the data had a certain value.

Memory access operations may not be able to complete within a guaranteed amount of time (and hence are considered unbounded) due to the presence of other entities that share access to the memory system. For example, where the processing circuitry is a core or an element thereof, one or more other cores may have access to the same memory system such that behaviour of those other cores can affect how long it takes the memory system to handle memory access operations from the processing circuitry.

Unlike the memory access operations described earlier such as the load or store operations, for the first type of memory access operation, it may not be desirable to begin handling an interrupt received while the memory access operation of the first type was being handled by the memory system for the following reasons.

Firstly, because the memory access operation of the first type requires a response from the memory system, the processing circuitry needs to be able to handle this response when it is returned from the memory system. However, if the interrupt is taken while the memory access operation is in-flight such that the processing circuitry performs a context switch, the processing circuitry may not be in a position to handle this response when it is returned.

Secondly, the memory access operation cannot simply be aborted and allowed to be executed again because the memory access operation is able to change the contents of the data stored in the memory system. Therefore, if the change to the data has been made by the time that the memory access operation is aborted, executing the memory access operation again after the interrupt has been handled will cause the change to be made twice. Moreover, if the memory access operation is aborted, it may not be known to the processing circuitry whether the change to the data had been committed at the time the memory access operation had been aborted. It may also not be possible for the processing circuitry to read the memory to determine if the operation was committed or not as it may not be possible to establish whether any change to the contents of the memory was due to the aborted operation that led to a change in the contents of the memory or a separate operation.

Thirdly, since the time taken by the memory system to handle the memory access operation is unbounded, if an approach were taken whereby the processing circuitry is stalled until the memory access operation is complete, the time taken to handle the interrupt would then be unbounded due to the need to wait for the memory access operation to complete.

In accordance with the techniques described herein, there is provided an apparatus comprising processing circuitry (such as a central processing unit (CPU) or graphics processing unit (GPU) or an element thereof) and a memory system, wherein the memory system is operable in response to the first type of memory access operation. To address the problems described above and ensure that interrupts received while the memory system is handling memory access operations of the first type, the apparatus also comprises memory access operation handling circuitry.

The memory access operation handling circuitry is configured such that in response to receiving an indication of an interrupt to be taken by the processing circuitry, the memory access operation handling circuitry determines whether the memory access operation has reached a stage for which a remaining time to complete the memory access operation will be bounded. This determination may for example be done based on identifying which state of a state machine associated with the handling of the memory access operation has been reached by the memory system. If the memory access operation handling circuitry determines that a state for which it is known that the remaining time to complete the memory access operation will be bounded, then the memory access operation handling circuitry may make the determination that the remaining time to complete the memory access operation will be bounded. On the other hand, if such a state has not yet been reached by the memory system, the memory access operation handling circuitry may be determine that the time remaining to complete the handling of the memory access operation will be unbounded. The stage at which the remaining time to complete the memory access operation becomes bounded may correspond to a stage at which another core that accesses the same memory system can no longer be prioritised above the memory access operation, such that the memory access operation can no longer be delayed by virtue of memory access operations from that other core.

If the remaining time to complete the memory access operation is bounded, the memory access operation can be completed before allowing the interrupt to be handled whilst still allowing the interrupt to be handled in bounded time. Thus, when the remaining time to complete the memory access operation is bounded, the memory access operation handling circuitry is configured to stall the interrupt until the memory access operation has completed. Once the memory access operation has been completed, the memory access operation handling circuitry allows the interrupt to be handled. This allows the memory access operation of the first type to be progressed such that any change to the contents of data associated with the memory access operation can be carried out and the response returned to the processing circuitry whilst still handling the interrupt within bounded time.

On the other hand, if the memory access operation handling circuitry determines that the remaining time to complete the memory access operation is unbounded, the memory access operation of the first type cannot be allowed to complete before the interrupt is handled since this would result in the time taken to handle the interrupt being unbounded. Thus, in this case, the memory access operation handling circuitry is configured to abort the memory access operation and allow the interrupt to be taken. This ensures that the interrupt is taken within bounded time. To abort the interrupt, the memory system may ensure that any change to the contents of data in the memory system as a result of the memory access operation is either not performed or is reversed.

In some examples, the stage at which the time taken to complete the memory access operation becomes bounded coincides with a stage for which handling of the memory access operation is irreversible. Beyond this stage therefore, the memory access operation cannot be aborted (e.g., because a change to the contents of the memory system has been irreversibly committed); however, beyond this same stage, if an interrupt were to be received, the memory access operation could be completed in bounded time before allowing the interrupt to be taken.

In some examples, if the indication of the interrupt is received by the memory access operation handling circuitry while the memory access operation of the first type is in-flight in the memory system, the memory access operation handling circuitry causes the memory system to prioritise handling of the memory access request, thereby allowing the memory access request to be completed more quickly. In some examples, this prioritisation itself allows the memory access request to be completed within bounded time (e.g., because the memory access request is prioritised over memory access requests from other cores that have access to the memory system).

Thus, according to the techniques described herein, the apparatus is able to handle, in bounded time, an interrupt received while a memory access request of the first type is being handled by the memory system whilst also ensuring that the memory access operation itself is properly handled and does not lead to data returned from the memory system being erroneously discarded or data in the memory system being altered in an unintended manner.

One particular memory access operation of the first type is a write-exclusive operation. A write-exclusive operation is a write operation (i.e., an operation that involves changing the contents of a particular data item in the memory system). However, for the write-exclusive operation, whether the change to the contents of the particular data item is carried out is dependent on whether that particular data item is tagged in the memory system as being for exclusive access by the processing circuitry. The tag to indicate exclusivity may be set by a previous operation (e.g., a load-exclusive operation) that marks the address of the data item as being for exclusive access by the processing circuitry (which may correspond to one of a number of cores in a processor). If, in the intervening period between the data item being tagged as being for exclusive access by the core and the write-exclusive operation being executed, another core accesses that data item, the tag will be cleared. In some examples, the tag is only cleared if another core modifies the data, while another core only reading the data may not lead to the tag being cleared. As such, when the write-exclusive operation is executed, the tag will not indicate the data item as being for exclusive access by the processing circuitry and the write-exclusive operation will not lead to a change in the contents of that data item. Conversely, if the tag has not been cleared and still indicates that the data item is for exclusive access by the core, the write to the particular data item will be carried out. Depending on whether the change to the contents of the particular data item was carried out, the memory system will provide a response to the processing circuitry to indicate whether the write-exclusive operation was able to be successfully carried out.

Using the write-exclusive operation in this way with the tag for data items, the apparatus can ensure that the particular data item will only be written to if the content of that data item has not been modified by another core while a particular section of code has been executed by the processing circuitry. However, the time taken to execute a write-exclusive operation is generally unbounded such that the operation cannot be guaranteed to complete within a given period of time. This is the case because checking the tag requires checking if other cores have a copy of the data and it may be difficult to guarantee that the time to carry out this checking is bounded. As such, the presently described techniques whereby the memory access operation handling circuitry determines whether to stall an interrupt or to abort the memory access operation and allow the interrupt to be taken may be employed to ensure that the interrupt can be handled in bounded time.

Another example of a memory access operation to which the techniques described herein may be applied is an atomic operation. An atomic operation comprises a plurality of sub-operations that are to be executed atomically. As used herein, executing the sub-operations atomically means that the sub-operations are executed fully without interruption from other threads or other cores. As such, while an atomic operation is executed, no other intervening operations may access a data item targeted by the atomic operation.

In an example of an atomic operation, the atomic operation involves the following three sub-operations: reading data from a data item in the memory system, adding a value to the data, and then writing the result of the addition to the data item. In this example therefore, a value stored in the memory system can be incremented using a single memory access operation, and in a manner that ensures that other threads/cores cannot read or change the value while the process of incrementing is being carried out. It will be appreciated that other forms of atomic operation with more or fewer sub-operations, and containing different sub-operations may be used.

In the example where an atomic operation is used to increment a value stored in the memory system, since another core may be accessing the data item, or otherwise due to conflicts with another core, the atomic operation cannot be handled within bounded time. By virtue of containing a write sub-operation and a read sub-operation which returns a value to the processing circuitry, the atomic operation is able to change the contents of data stored in the memory system and provide a response. Hence, the atomic operation is an example of the first type of memory access operation.

While the write-exclusive operation and the atomic operation have been discussed in detail, it will be appreciated that the present techniques are not limited to these particular forms of operation, and other memory access operations that are able to change the contents of data in the memory system, which require a response, and for which the time taken to handle the operation is unbounded may be subject to similar handling by the memory access operation handling circuitry.

The memory system could take a number of possible forms and in some examples involve only a main memory. However, in some examples the memory system comprises a main memory and at least one level of cache which may be arranged in a cache hierarchy. For example, the processing circuitry may comprise a core having a dedicated level 1 (L1) cache for that core which is in communication with main memory that is shared between several cores.

The memory system may comprise a cache that is operable according to a write-back arrangement, a write-through arrangement or both. According to a write-back arrangement, data that is written to the cache is stored in the cache in the modified form and the modified data is not automatically written to higher levels of cache at the point at which the data is written to the cache. The data that has been written to the cache will only be updated in any higher levels of cache and the main memory at a later point. As used herein, a higher level of cache or higher level of memory system refers to a cache/element of a memory system arranged logically further from the processing circuitry. Cache coherency structures are typically provided to ensure that the correct version of data is accessed when needed and to ensure that the higher levels of cache/main memory are updated as appropriate. According to a write-through arrangement however, when a change to data stored in the cache is made, the change is also made to the corresponding data stored in any higher levels of cache/main memory at the same point.

In some examples, a memory system comprises a cache that is operable according to both a write-back arrangement and a write-through arrangement. This may be achieved by providing the cache with different ports on which memory access operations can be received, with the port on which the memory access operation is received indicative of which of the write-back and write-through techniques are to be employed when handling the memory access operation. To support this operation, different ranges of addresses may be allocated in memory corresponding to memory locations for which write-back and write-through techniques are to be applied.

Where a cache operates according to a write-back arrangement, aborting the memory access operation when it is determined by the memory access operation handling circuitry that the remaining time to complete the memory access operation is unbounded may comprise preventing a change to the contents of data in the cache. Since the update to the data stored in the cache would only have been effected in the cache (and not in higher levels of cache/main memory) at the point at which the change is made in the cache, there is no need to handle aborting in higher levels of cache/main memory.

In some examples, even when operating according to a write-back arrangement, some operations will bypass the cache for performance reasons to write directly to a higher level of the memory system. This may be done when it is expected that the data will not be needed again by the core to which the cache belongs core so it is advantageous to write the data directly to a higher level of the memory system. In such examples, the operation may be forced to not bypass the cache in this way such that the data is written to the cache in question. This approach therefore avoids updating higher levels of the memory system at the point at which the data is written thereby avoiding the need to handle aborting the operation in the higher levels.

On the other hand, where the cache operates according to a write-through arrangement, aborting the memory access operation may comprise preventing a change to the contents of data in the cache and in one or more higher levels of the memory system (such as higher levels of cache/main memory). Suppressing this change to the contents of data in the cache as well as the higher levels therefore allows the memory access operation handling circuitry to ensure that the change does not take effect at any level of the memory system. If this were not done and only the change in the cache itself prevented, the data in higher levels of the memory system could be changed despite the memory access operation with which the change is associated being aborted.

In some examples, when carrying out a memory access operation on a cache that is operating according to a write-through arrangement, the memory system issues a request from the cache to the one or more higher levels of the memory system. For example, the request may request an identifier (ID) of a buffer into which the data to be changed can be written so as to update the data in the higher levels of the memory system. Once a confirmation has been received from the higher levels of the memory system, the cache can then provide the data to be written to the one or more higher levels of cache. The confirmation may for example confirm that the higher levels of the memory system are ready to receive the data and/or provide the ID of the buffer to which the data should be written such that the confirmation enables the cache to write-through the data to the one or more higher levels.

Within this framework, to abort a memory access operation the cache may be configured to provide an abort indication to the one or more higher levels of the memory system along with the data to be written. This abort indication provides an indication to the higher levels of cache that the memory access operation is to be aborted and that those levels of the memory system should not be updated to store the data to be provided. Therefore, in response to the abort indication, the higher levels of the memory system are configured to prevent the change to the contents of data associated with the memory access operation, thereby aborting the memory access operation.

This approach provides a mechanism for aborting a memory access operation within a cache operating according to a write-through arrangement within the framework that the memory system is already configured to handle by virtue of supporting write-through operation. Thus, significant modification to existing memory systems to support the ability to abort memory access operations can be avoided.

To avoid conflicts that could result in incorrect data occurring while a memory access operation is being handled by the memory system, the memory system may be configured to stall pending memory access operations (also referred to as hazarding) while a given memory access operation is being carried out by the memory system. Once the given memory access operation has reached a point at which the handling of further memory access operations will not lead to a conflict, the next pending memory access operation may be carried out. The point at which the given memory access operation will not conflict with any later memory access operations to be handled may for example be the point at which the memory access operation is determined to be completed. Where the memory access operation is aborted, the stall of the pending memory access operations may instead be released (i.e., the hazards released) when the process of aborting the memory access operation has been completed. This is particularly important where a cache is operating according to a write-through arrangement for which the cache at which the pending access operations are stalled may not be the same cache at which the process of handling or aborting the memory access is completed.

Where a cache is operating according to a write-through arrangement, the higher levels of cache may notify the cache at the lower level that the memory access operation has been completed, or in the case of aborting the memory access operation, that the memory access operation has been successfully aborted. In some examples, this notification takes the form of a completion indication provided by the higher levels of the memory system to the cache. Thus, in the case where the memory access operation is aborted once the change to the contents of data due to be performed as a result of the memory access operation has been successfully prevented in the higher levels, the higher levels of the memory system are configured to provide the completion indication to indicate that the further memory access operations will not conflict with aborting the memory access operation. Therefore, upon receiving the completion indication, the memory system and specifically the cache in question can stop stalling the pending memory access operations and allow one or more further memory access operations to proceed.

In some examples, the memory system provides a plurality of ports for receiving memory access operations. These ports may be associated with different behaviours for handling the memory access operations such that depending on the port on which a memory access operation is received, the memory system may handle the memory access operation differently. For such arrangements, the point at which a memory access operation being handled or aborted in one of the higher levels of the memory system will no longer conflict with any new memory access operations may differ for further memory access operations received on the same port as the original memory access operation or a different port to the original memory access operation. When a memory access operation is in-flight therefore, hazards may initially be set on all ports to prevent further memory access operations being processed that could lead to a conflict. To avoid unnecessarily delaying all further memory access operations in the period where only memory access operations received on the same port as the in-flight memory access operation would conflict with the in-flight memory access operation, the higher levels of memory system are configured to provide an early completion response. The early completion response is provided in advance of the completion response and indicates that further memory access operations that are pending and that were received on ports other than the port on which the in-flight memory access operation was received, may be released (i.e., that hazards set for those ports can be released). This early completion response may be provided when it is determined that the memory access operation has reached a certain point in its handling at which further memory access operations received on a different port would not conflict with the handling of the memory access operation or when the process of aborting the memory access operation has reached a stage at which no conflict would occur for such further memory access operations.

In response to the early completion response, the memory system (e.g., the cache) may allow further memory access operations that are not associated with the port on which the in-flight memory access operation was received to proceed (i.e., be handled by the memory system). Later, once the completion response has been received, the remaining memory access operations received on the same port as the memory access operation that was being handled or aborted may be allowed to proceed.

In this way, the apparatus is able to ensure conflicts do not occur between memory access operations that are being handled by the memory system and further memory access operations, even where a memory access operation is being aborted in the memory system. This approach, by providing similar mechanisms for both aborting and handling memory access operations, reduces the extent to which apparatuses need to be modified in order to handle the aborting of memory access operations in order to enable interrupts to be taken.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Particular examples will now be described with reference to the figures.

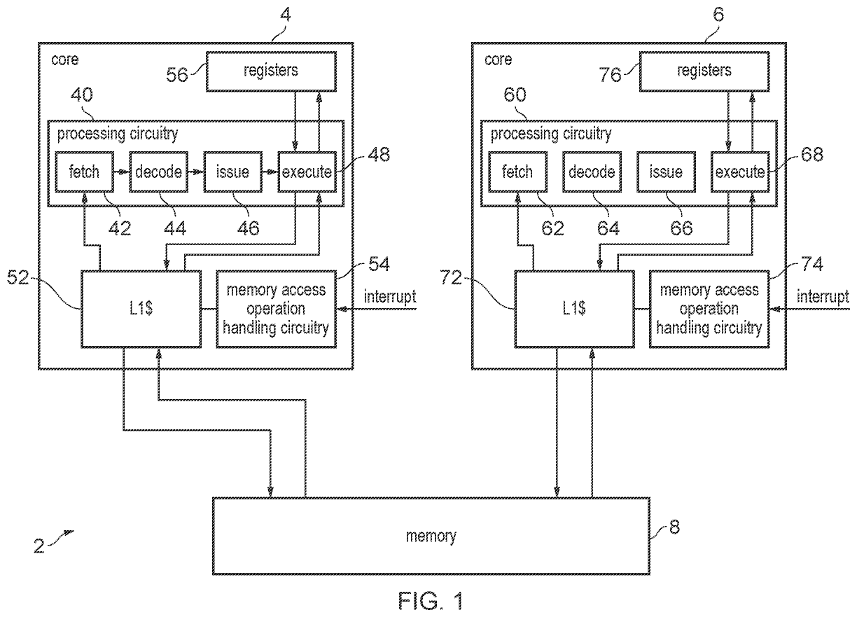

FIG. 1 is a schematic illustrating an apparatus 2 in which the techniques described herein may be applied. The apparatus 2 has two cores 4, 6 which each have processing circuitry 40, 60. The processing circuitry 40, 60 has a processing pipeline which includes a number of pipeline stages. In this example, the pipeline stages include a fetch stage 42, 62 for fetching instructions from a level 1 (L1) cache 52, 72; a decode stage 44, 64 for decoding the fetched program instructions to generate micro-operations to be processed by remaining stages of the pipeline; an issue stage 46, 66 for checking whether operands required for the micro-operations are available in a register file 56, 76 and issuing micro-operations for execution once the required operands for a given micro-operation are available; and an execute stage 48, 68 for executing data processing operations corresponding to the micro-operations by processing operands read from the register file 56, 76 to generate result values which can be written back to the register file 56, 76. It will be appreciated that this is merely one example of possible pipeline architecture, and other systems may have additional stages or a different configuration of stages. For example in an out-of-order processor an additional register renaming stage could be included for mapping architectural registers specified by program instructions or micro-operations to physical register specifiers identifying physical registers in the register file 56, 76.

The execute stage 48, 68 is able to communicate with the L1 cache 52, 72 to carry out memory access operations. Memory access operations may be issued to the L1 cache 52, 72 by the processing circuitry 40, 60 to cause the L1 cache 52, 72 and the main memory 8, which stores data cached by the L1 caches 52, 72, to access data in the L1 cache 52, 72 or memory 8.

Together the L1 caches 52, 72 and the memory 8 may be termed the memory system. In the example shown in FIG. 1, it is assumed that the memory system comprises main memory 8 and a level 1 (L1) cache 52, 72 for each of the cores 4, 6. It will however be appreciated that the memory system may comprise other cache hierarchies having even more or fewer, or differently arranged caches. In some examples, the memory system may not contain any caches and comprises only the main memory 8.

The cores 4, 6 are responsive to interrupts which are requests for the processing circuitry 40, 60 to interrupt the currently executed code and instead handle (or take) the interrupt by executing code associated with the interrupt. For some memory access operations, if an interrupt is received by the core 4, 6 while the memory access operation is being handled by the memory system, there is no need to wait until the memory access operation is completed. Instead, the interrupt can be taken straight away. For some memory access operations, the operation is guaranteed to complete within a particular amount of time (i.e., the time taken is bounded) and so if the core 4, 6 allows the memory access operation to complete before taking the interrupt, a certain performance of the interrupt can still be guaranteed. In many cases, the ability to guarantee such a performance with which an interrupt can be handled is more important than the speed with which the interrupt can be handled in the fastest or even average case.

However, for some memory access operations, referred to as memory access operations of a first type, the characteristics of the memory access operation render these operations unsuitable for aborting in all cases and unsuitable for simply allowing to execute in the memory system while the interrupt is taken such that the memory access operation may be executed again once the interrupt has been handled. For this first type of memory access operation, the time taken to carry out the memory access operation is unbounded, a response is required by the processing circuitry in respect of the memory access operation, and the memory access operation is capable of modifying data in the memory system.

To ensure proper handling of such memory access operations and enable the interrupt to be handled within bounded time, each core is provided with memory access operation handling circuitry 54, 74. The memory access operation handling circuitry 54, 74 is arranged to determine, when an interrupt is received by the core 4, 6, whether there are any memory access operations of the first-type in-flight in the memory system. If there are such memory access operations of the first type, the memory access operation handling circuitry 54, 74 determines whether the memory access operation has reached a stage for which the remaining time to complete the memory access operation will be bounded. If the remaining time to complete the memory access operation will be bounded, the memory access operation handling circuitry 54, 56 stalls the interrupt until the memory access operation has completed at which point the interrupt is taken. Otherwise, if the memory access operation cannot be handled by the memory system within bounded time, the memory access operation handling circuitry 54, 56 is arranged to abort the memory access operation and allow the interrupt to be taken.

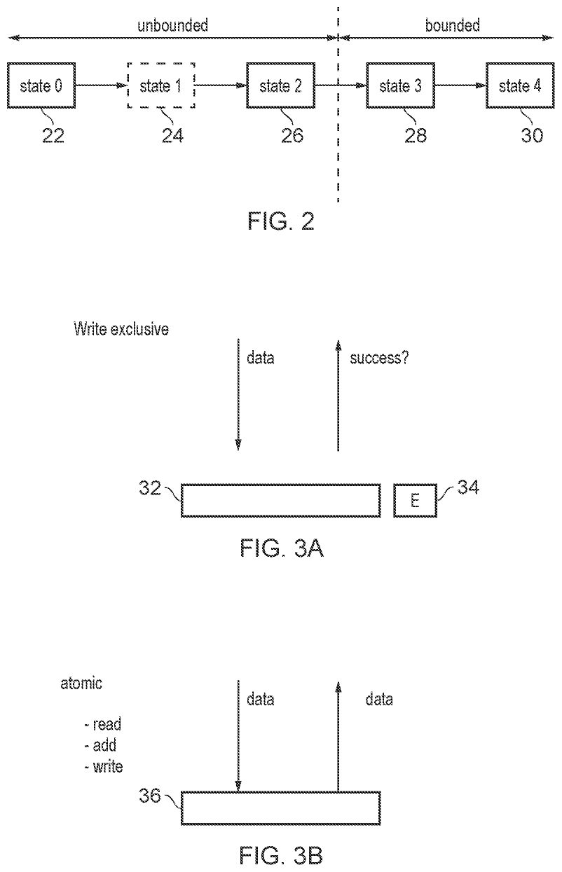

FIG. 2 is a timing diagram showing the progression of a memory access operation as the memory access operation is handled by the memory system. In the example shown in FIG. 2, the memory access operation can be considered as being handled by a state machine where handling of the memory access operation involves progressing through the various states of the state machine. As illustrated in FIG. 2, handling a particular memory access operation of the first type involve five states 22-30. While the progress of memory access operation corresponds to state 0, state 1, or state 2, the remaining time to complete the memory access operation is unbounded. This may for example be due to the operations involved to transition between states (i.e., to progress the memory access operation) being dependent on information from other cores or due to possible delays in handling of the memory access operation due to memory access operations originating from other cores. Additionally, or alternatively, the number of states may vary, for example, if the data item to which the memory access operation pertains needs to be obtained from another level of the memory system or obtained in a particular state (e.g., a modifiable state). This uncertainty as to the processing involved to handle the memory access operation is represented for state 1 shown in dashed lines.

However, once the memory access operation has reached state 3, the time taken to complete the memory access operation is bounded. That is, the time taken to progress through states 3 and 4 is known to be less than a particular value. It will be appreciated that this time may be expressed in terms of a number of clock cycles which may itself correspond to an amount of time in seconds.

In some cases, the memory access operation may be able to be prioritised such that memory access operation can be handled more quickly than it would otherwise would without such prioritisation. This prioritisation may itself cause the remaining time to complete the memory access operation to become bounded (e.g., by prioritising the memory access operation above conflicting memory access operations that could delay the memory access operation).

The point at which the time taken to complete the memory access operation becomes bounded (stage 3 in FIG. 2) may coincide with a stage at which the operation becomes irreversible. As such, before this point, the memory access operation may be aborted whilst after this point, the memory access operation cannot be safely aborted but can be guaranteed to complete within a given period of time and so can be completed while a pending interrupt is stalled whilst still allowing the interrupt to be handled in bounded time.

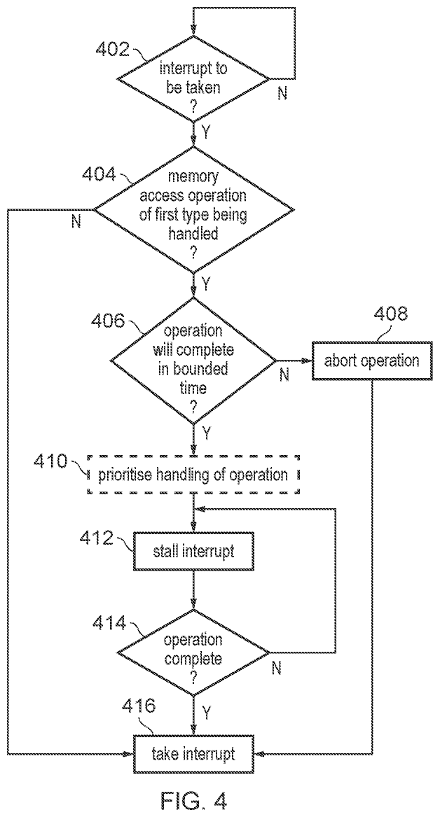

FIG. 3A depicts a write-exclusive operation as an example of the first type of memory access operation with respect to which the techniques described herein may be applied. As illustrated in FIG. 3A, the write-exclusive operation involves a write operation to a particular data item 32. However, rather than simply writing to the data item 32, the write-exclusive operation involves checking a tag 34 that indicates whether the data item 32 is for exclusive access by the processing circuitry (e.g., processing circuitry of the core 4, 6) from which the write-exclusive operation originated. If the tag 34 indicates that the data item is for exclusive access by the processing circuitry, the write operation is performed and memory system indicates the success of the write-exclusive operation to the processing circuitry. On the other hand, if another core has accessed the data item 32 since the tag 34 was set to indicate the data item 32 as being for exclusive access, the tag 34 will have been cleared and so will no longer indicate the data item 32 is for exclusive access by the core from which the write-exclusive operation originated. In this case, the write operation will not be carried out and the memory system will indicate to the processing circuitry that the write-exclusive operation could not be carried out.

As shown in FIG. 3A, a tag 34 is provided for the data item 32. Other data items (not shown) in the memory system are provided with their own tags to indicate whether the respective data item is for exclusive access by a particular core. In some examples however, fewer tags (e.g., a single tag) are provided. For example, a single indicator may be provided to indicate the address of a data item being tracked such that if the indicator validly indicates the address of a particular data item, that data item is tagged as being for exclusive access by a particular core.

FIG. 3B depicts another example of a memory access operation of the first type in the form of an atomic operation. The atomic operation of FIG. 3B involves three sub-operations: read, add, and write, although it will be appreciated that other atomic operations may involve different sub-operations and may involve more or fewer sub-operations. In response to the atomic operation targeting a particular data item 36, the memory system is configured to read the data from the data item 36, add to that data a value that has been provided, and store the result back in the data item 36. The data read from the data item 36 is then returned to the processing circuitry.

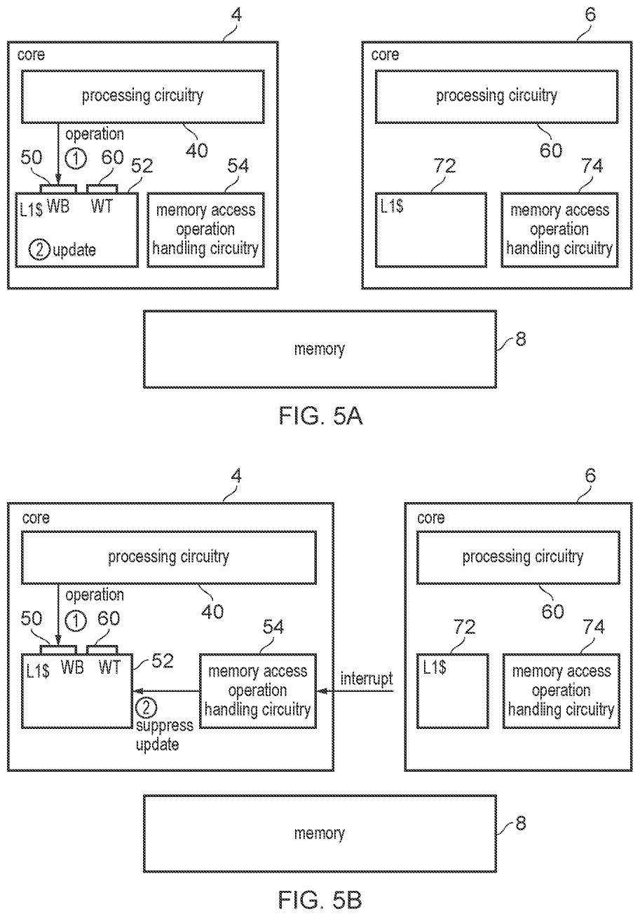

FIG. 4 is a flowchart illustrating the operation of the apparatus 2 in accordance with the techniques described herein. At step 402, the memory access operation handling circuitry 54, 56 determines whether there is an interrupt to be taken by the core 4, 6. If there is no interrupt, there is no action to be taken by the memory access operation handling circuitry 54, 56.

However, if an interrupt is received by the core 4, 6, an indication of the interrupt is provided to the memory access operation handling circuitry 54, 56 and the memory access operation handling circuitry 54, 56 determines at step 404 whether the memory system is handling a memory access operation of the first type that originated from the same core 4, 6 as the memory access operation handling circuitry 54, 56. If no memory access operation of the first type is being handled, the interrupt can safely be taken at step 416 thereby allowing the interrupt to be handled within bounded time.

In some examples, the memory access operation handling circuitry is additionally responsive to a type of memory access operation that is not of the first type, cannot be aborted and does not complete in bounded time. In this case, a mechanism may be provided to prevent such operations being initiated in situations where the time taken to complete a memory access operation needs to be bounded. However, where the need to complete the memory access operation in bounded time is not so important and these operations are carried out, the memory access operation handling circuitry may be configured to respond to an interrupt being received to stall the interrupt until the memory access operation is completed. Although not illustrated in FIG. 4, this would correspond to a path from step 404 to step 412 when such an operation was being handled.

On the other hand, if there is a pending memory access operation of the first type in the memory system, the memory access operation handling circuitry 54, 56 determines at step 406 whether the memory access operation if the first type will complete in bounded time. If the memory access operation will not complete in bounded time, the interrupt cannot be stalled until the memory access operation completes since this may take longer than is acceptable for handling such interrupts. As such, in this case, the memory access operation is aborted at step 408 and the interrupt taken at step 416.

When the operation is able to be completed within bounded time, the memory access operation handling circuitry 54, 56 causes the interrupt to be stalled at step 412 and in some examples causes handling of the memory access operation to be prioritised by the memory system at step 410.

Once the memory access operation has been completed, and the memory access operation handling circuitry 414 determines this to be the case at step 414, the interrupt can be taken at step 416. Since the memory access operation was able to be completed within bounded time, the interrupt is also able to be handled within bounded time in this case.

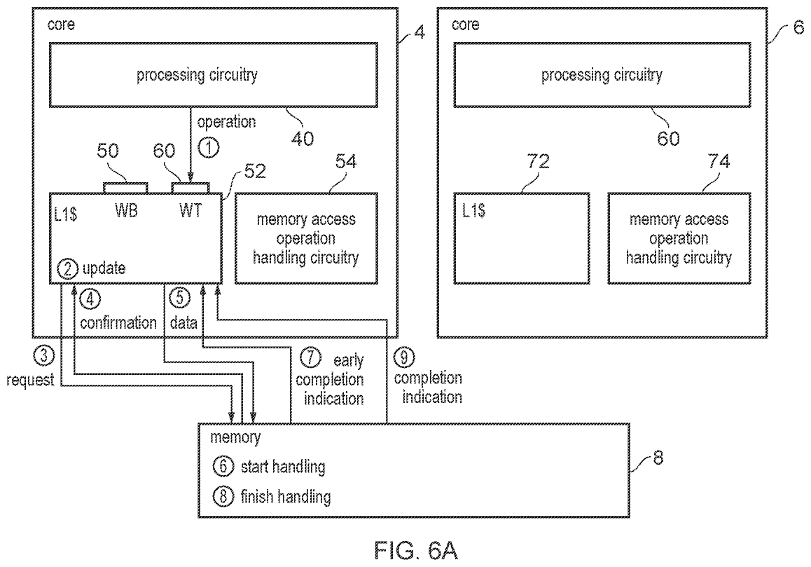

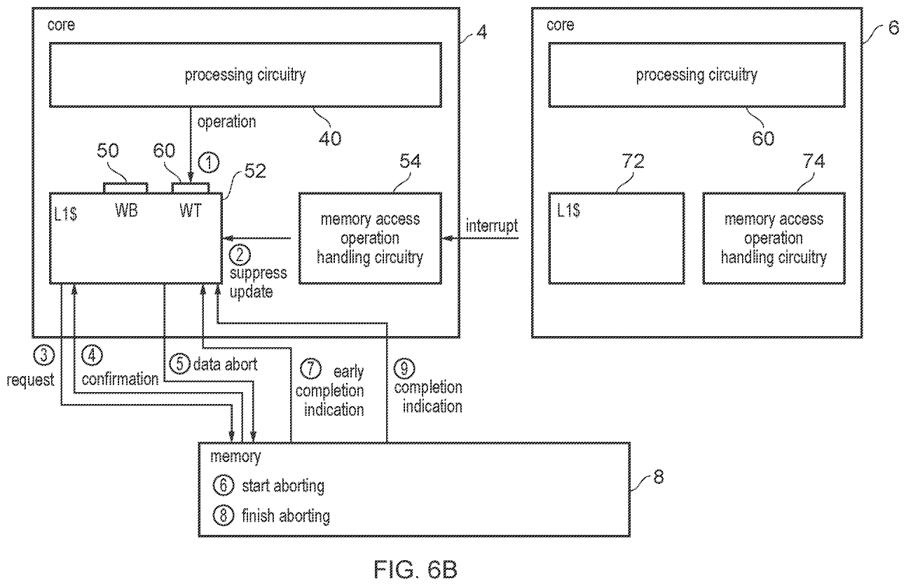

FIGS. 5A-5B and 6A-6B illustrate the apparatus 2 with some details omitted for ease of understanding. (For example, details of requests for the data from higher levels of the memory system, where the data is not already present in the L1 cache 52 are not shown). In these figures, the L1 cache 52 of the core 4 is provided with two ports 50 and 60 corresponding to write-back and write-through behaviour. For memory access operations received on the write-back port 50, the operations are handled according to a write-back arrangement while memory access operations received on the write-through port 60 are handled according to a write-through arrangement.

FIG. 5A is a schematic illustrating a memory access operation being handled by a memory system operating according to a write-back arrangement. As shown in FIG. 5A, a memory access operation is received on the write-back port 50 in step 1. In response to the memory access operation, the L1 cache 52 updates the contents of data in the L1 cache 52 based on the memory access operation at step 2. Since the operation was received on the write-back port, there is no need to update the corresponding data item in memory 8 at this stage.

Although the memory 8 is depicted as a single memory, in some examples, two separate memories are provided such that if the memory access operation is received on the write-back port 50, the memory access operation is directed to a first memory and if the memory access operation is received on the write-through port 60, the memory access operation will be directed to a second memory.

FIG. 5B illustrates the process of aborting a memory access operation in the same apparatus 2 according to the write-back arrangement. In this case, at step 1 an operation is received by the L1 cache 52 on the write-back port 50. While handling the operation, an interrupt is received by the core 4. The memory access operation handling circuitry 54 determines that a memory access operation of the first type is being handled by the L1 cache 52 and that the time remaining to handle the memory access operation is unbounded. As such, the memory access operation handling circuitry 54 aborts the memory access operation by suppressing the update to the contents of data in the L1 cache 52 in step 2. There is no need to take any action with respect to the memory 8 since the cache 52 is operating according to a write-back arrangement and so will not be updating the memory 8 at this stage.

FIG. 6A illustrates a memory access operation being handled by a memory system operating according to a write-through arrangement. In this example therefore, and as shown in step 1 of FIG. 6A, a memory access operation is received by the L1 cache 52 from the processing circuitry 40 on the write-through port 60. The L1 cache 52 then carries out the memory access operation and updates the data item targeted by the memory access operation at step 2. Since the memory access operation was received on the write-through port 60, the L1 cache 52 then needs to write-through the update to the memory 8 which is at a higher level in the memory system. To do this, the L1 cache 52 first sends a request to the memory 8 at step 3 whereupon a confirmation is sent by the memory 8 at step 4. In addition to confirming that the memory 8 is able to receive the data to be written, the confirmation may provide an identifier of a write buffer into which the data should be written to allow the memory 8 to update the data item.

In response to the confirmation, the L1 cache 52 provides the data to the memory 8 at step 5. The memory 8 begins handling this data to carry out the memory access operation at step 6. During this period, the L1 cache 52 prevents any further memory access operations from being carried out in order to avoid those further memory access operations conflicting with the in-flight memory access operation being handled by the memory 8.

Once the handling of the memory access operation in the memory 8 has reached a point at which the memory system can handle further memory access operations originating from ports other than the port 60 on which the memory access operation was received, the memory 8 provides an early completion indication to the L1 cache 52 at step 7. Responsive to the early completion indication, the L1 cache 52 allows further memory access operations pending at the L1 cache 52 on ports other than the write-through port 60 to progress but maintains the hazard on the write-through port 60 to prevent conflicts occurring with respect to memory operations received on that port.

Later, once the memory 8 has finished handling the memory access operation at step 8, the memory 8 provides a completion indication to the L1 cache 52 at step 9. This completion indication indicates to the L1 cache 52 that the memory access operation has completed and the hazards on the write-through port 60 can be released, thereby allowing further memory access operations received on the write-through port 60 to progress.

FIG. 6B illustrates the aborting of a memory access operation in a memory system operating according to a write-through arrangement. In step 1 of FIG. 6A, a memory access operation is received by the L1 cache 52 from the processing circuitry 40 on the write-through port 60. While handling the operation, an interrupt is received by the core 4. The memory access operation handling circuitry 54 determines that a memory access operation of the first type is being handled by the L1 cache 52 and that the time remaining to handle the memory access operation is unbounded. As such, the memory access operation handling circuitry 54 aborts the memory access operation by suppressing the update to the contents of data in the L1 cache 52 in step 2.

Unlike the case depicted in FIG. 5B, here the memory access operation handling circuitry 54 needs to take action with respect to the memory 8. With the request at step 3 and confirmation at step 4 carried out as explained above with respect to FIG. 6A, at step 5, in addition to providing the data to be written as part of the memory access operation, the L1 cache 52 provides an abort indication to signal to the memory 8 that the memory access operation is to be aborted.

The memory 8 begins aborting the memory access operation at step 6. During this period, the L1 cache 52 prevents any further memory access operations from being carried out in order to avoid those further memory access operations conflicting with the in-flight memory access operation being aborted by the memory 8.

Once the memory 8 has reached a point at which the memory system can handle further memory access operations originating from ports other than the port 60 on which the memory access operation was received, the memory 8 provides an early completion indication to the L1 cache 52 at step 7. Responsive to the early completion indication, the L1 cache 52 allows further memory access operations pending at the L1 cache 52 on ports other than the write-through port 60 to progress but maintains the hazard on the write-through port 60 to prevent conflicts occurring with respect to memory operations received on that port.

Later, once the memory 8 has finished aborting the memory access operation at step 8, the memory 8 provides a completion indication to the L1 cache 52 at step 9. This completion indication indicates to the L1 cache 52 that the memory access operation has finished aborting the memory access operation and the hazards on the write-through port 60 can be released, thereby allowing further memory access operations received on the write-through port 60 to progress.

Thus there has been described an apparatus and a method with which a pending memory access operation in-flight in a memory system can be selectively aborted based on the progress of that memory access operation so as to ensure that a pending interrupt can be handled within a bounded period of time. Further, there has been described a mechanism by which such memory access operations can be aborted in caches operating according to either a write-back or a write-through arrangement in an efficient manner and without requiring extensive modification to the mechanisms that may already be provided for handling the memory access operations themselves.

The techniques described herein are presented in the following numbered examples.

Example 1. An apparatus comprising: processing circuitry to execute instructions; a memory system to store data and provide access to the data in response to memory access operations from the processing circuitry, wherein the memory system is operable in response to a first type of memory access operation for which: a time taken to handle the memory access operation is unbounded, the memory access operation is able to change contents of data stored in the memory system, and a response is required from the memory system in respect of the memory access operation; and memory access operation handling circuitry responsive to receiving, when a memory access operation of the first type of memory access operation is being handled by the memory system, an indication of an interrupt to be taken, to determine whether the memory access operation has reached a stage for which a remaining time to complete the memory access operation will be bounded; wherein the memory access operation handling circuitry is responsive: to the remaining time to complete the memory access operation being bounded, to stall the interrupt until the memory access operation has completed; and to the remaining time to complete the memory access operation being unbounded, to abort the memory access operation and allow the interrupt to be taken.

Example 2. The apparatus according to example 1, wherein the time taken to handle the memory access operation is unbounded such that the memory access operation is not guaranteed to complete within a predetermined period of time.

Example 3. The apparatus according to example 1 or example 2, wherein: the first type of memory access operation is a write-exclusive operation for which a change to the contents of a particular data item indicated by the write-exclusive operation is contingent on the particular data item being tagged in the memory system as being for exclusive access by the processing circuitry.

Example 4. The apparatus according to any preceding example, wherein: the first type of memory access operation is an atomic operation comprising a plurality of sub-operations to be executed atomically.

Example 5. The apparatus according to any preceding example, wherein: for a given memory access operation, the stage for which the remaining time to complete the memory access operation will be bounded coincides with a stage for which handling of the memory access operation is irreversible.

Example 6. The apparatus according to any preceding example, wherein: the memory access operation handling circuitry is responsive to receiving the indication of the interrupt when the remaining time to complete the memory access operation is unbounded, to cause the memory system to prioritise handling of the memory access operation.

Example 7. The apparatus according to example 6, wherein: prioritising the handling of the memory access operation by the memory system causes the memory access operation to be handled in bounded time.

Example 8. The apparatus according to any preceding example, wherein: the memory system comprises main memory and at least one level of cache.

Example 9. The apparatus according to any preceding example, wherein: the memory system comprises a cache that operates according to a write-back arrangement; and the memory access operation handling circuitry is configured to abort the memory access operation by preventing a change to the contents of data in the cache.

Example 10. The apparatus according to any preceding example, wherein: the memory system comprises a cache that operates according to a write-through arrangement; and the memory access operation handling circuitry is configured to abort the memory access operation by preventing a change to the contents of data in the cache and one or more higher levels of the memory system, located logically further from the processing circuitry than the cache.

Example 11. The apparatus according to any preceding example, wherein: the memory system comprises a cache that is operable according to write-back arrangement and a write-through arrangement.

Example 12. The apparatus according to example 10, wherein: to handle the memory access operation, the memory system is configured to issue a request from the cache to the one or more higher levels of the memory system and, once a confirmation has been received from the one or more higher levels of the memory system, provide data to be written to the one or more higher levels of cache; to abort the memory access operation, the cache is configured to provide, with the data to be written, an abort indication; and the one or more higher levels of the memory system are configured to prevent, in response to the abort indication, the change to the contents of data associated with the memory access operation in the one or more higher levels of the memory system.

Example 13. The apparatus according to any of examples 10-12, wherein: the memory system is configured to stall, when handling the memory access operation of the first type of memory access operation, further memory access operations until the memory access operation has completed or is aborted.

Example 14. The apparatus according to example 13, wherein: the one or more higher levels of the memory system are configured to provide a completion indication once the change to the contents of data associated with the memory access operation in the one or more higher levels of the memory system has been prevented to indicate that handling of the further memory access operations will not conflict with aborting the memory access operation; the memory system is responsive to the completion indication to allow the further memory access operations to proceed.

Example 15. The apparatus according to example 14, wherein: the memory system provides a plurality of ports for receiving memory access operations; the one or more higher levels of the memory system are configured to provide an early completion response in advance of the completion response to indicate that further memory access operations received on ports other than a port associated with the memory access operation will not conflict with aborting the memory access operation; and the memory system is responsive to the early completion indication to allow memory access operations of the further memory access operations associated with the ports other than the port associated with the memory access operation to proceed.

Example 16. A method comprising: executing instructions by processing circuitry; storing data by a memory system; providing access to the data in response to memory access operations from the processing circuitry; wherein the memory access operations comprise a first type of memory access operation for which: a time taken to handle the memory access operation is unbounded, the memory access operation is able to change contents of data stored in the memory system, and a response is required from the memory system in respect of the memory access operation; and in response to receiving, when a memory access operation of the first type of operation is being handled by the memory system, an indication of an interrupt to be taken, determining whether the memory access operation has reached a stage for which a remaining time to complete the memory access operation will be bounded; responsive to the remaining time to complete the memory access operation being bounded, stalling the interrupt until the memory access operation has completed; and responsive to the remaining time to complete the memory access operation being unbounded, aborting the memory access operation and allowing the interrupt to be taken.

Example 17. A non-transitory computer-readable medium to store computer-readable code for fabrication of an apparatus comprising: processing circuitry to execute instructions; a memory system to store data and provide access to the data in response to memory access operations from the processing circuitry, wherein the memory system is operable in response to a first type of memory access operation for which: a time taken to handle the memory access operation is unbounded, the memory access operation is able to change contents of data stored in the memory system, and a response is required from the memory system in respect of the memory access operation; and memory access operation handling circuitry responsive to receiving, when a memory access operation of the first type of memory access operation is being handled by the memory system, an indication of an interrupt to be taken, to determine whether the memory access operation has reached a stage for which a remaining time to complete the memory access operation will be bounded; wherein the memory access operation handling circuitry is responsive: to the remaining time to complete the memory access operation being bounded, to stall the interrupt until the memory access operation has completed; and to the remaining time to complete the memory access operation being unbounded, to abort the memory access operation and allow the interrupt to be taken.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. An apparatus comprising:
processing circuitry to execute instructions;
a memory system to store data and provide access to the data in response to memory access operations from the processing circuitry, wherein the memory system is operable in response to a first type of memory access operation for which:
a time taken to handle the memory access operation is unbounded,
the memory access operation is able to change contents of data stored in the memory system, and
a response is required from the memory system in respect of the memory access operation; and
memory access operation handling circuitry responsive to receiving, when a memory access operation of the first type of memory access operation is being handled by the memory system, an indication of an interrupt to be taken, to determine whether the memory access operation has reached a stage for which a remaining time to complete the memory access operation will be bounded;
wherein the memory access operation handling circuitry is responsive:
to the remaining time to complete the memory access operation being bounded, to stall the interrupt until the memory access operation has completed; and
to the remaining time to complete the memory access operation being unbounded, to abort the memory access operation and allow the interrupt to be taken.

2. The apparatus according to claim 1, wherein the time taken to handle the memory access operation is unbounded such that the memory access operation is not guaranteed to complete within a predetermined period of time.

3. The apparatus according to claim 1, wherein:
the first type of memory access operation is a write-exclusive operation for which a change to the contents of a particular data item indicated by the write-exclusive operation is contingent on the particular data item being tagged in the memory system as being for exclusive access by the processing circuitry.

4. The apparatus according to claim 1, wherein:
the first type of memory access operation is an atomic operation comprising a plurality of sub-operations to be executed atomically.

5. The apparatus according to claim 1, wherein:
for a given memory access operation, the stage for which the remaining time to complete the memory access operation will be bounded coincides with a stage for which handling of the memory access operation is irreversible.

6. The apparatus according to claim 1, wherein:
the memory access operation handling circuitry is responsive to receiving the indication of the interrupt when the remaining time to complete the memory access operation is unbounded, to cause the memory system to prioritise handling of the memory access operation.

7. The apparatus according to claim 6, wherein:
prioritising the handling of the memory access operation by the memory system causes the memory access operation to be handled in bounded time.

8. The apparatus according to claim 1, wherein:
the memory system comprises main memory and at least one level of cache.

9. The apparatus according to claim 1, wherein:
the memory system comprises a cache that operates according to a write-back arrangement; and
the memory access operation handling circuitry is configured to abort the memory access operation by preventing a change to the contents of data in the cache.

10. The apparatus according to claim 1, wherein:
the memory system comprises a cache that operates according to a write-through arrangement; and
the memory access operation handling circuitry is configured to abort the memory access operation by preventing a change to the contents of data in the cache and one or more higher levels of the memory system, located logically further from the processing circuitry than the cache.

11. The apparatus according to claim 1, wherein:
the memory system comprises a cache that is operable according to write-back arrangement and a write-through arrangement.

12. The apparatus according to claim 10, wherein:
to handle the memory access operation, the memory system is configured to issue a request from the cache to the one or more higher levels of the memory system and, once a confirmation has been received from the one or more higher levels of the memory system, provide data to be written to the one or more higher levels of cache;
to abort the memory access operation, the cache is configured to provide, with the data to be written, an abort indication; and
the one or more higher levels of the memory system are configured to prevent, in response to the abort indication, the change to the contents of data associated with the memory access operation in the one or more higher levels of the memory system.

13. The apparatus according to claim 10, wherein:
the memory system is configured to stall, when handling the memory access operation of the first type of memory access operation, further memory access operations until the memory access operation has completed or is aborted.

14. The apparatus according to claim 13, wherein:
the one or more higher levels of the memory system are configured to provide a completion indication once the change to the contents of data associated with the memory access operation in the one or more higher levels of the memory system has been prevented to indicate that handling of the further memory access operations will not conflict with aborting the memory access operation;
the memory system is responsive to the completion indication to allow the further memory access operations to proceed.

15. The apparatus according to claim 14, wherein:
the memory system provides a plurality of ports for receiving memory access operations;
the one or more higher levels of the memory system are configured to provide an early completion response in advance of the completion response to indicate that further memory access operations received on ports other than a port associated with the memory access operation will not conflict with aborting the memory access operation; and
the memory system is responsive to the early completion indication to allow memory access operations of the further memory access operations associated with the ports other than the port associated with the memory access operation to proceed.

16. A method comprising:
executing instructions by processing circuitry;
storing data by a memory system;
providing access to the data in response to memory access operations from the processing circuitry;
wherein the memory access operations comprise a first type of memory access operation for which:
a time taken to handle the memory access operation is unbounded,
the memory access operation is able to change contents of data stored in the memory system, and
a response is required from the memory system in respect of the memory access operation; and
in response to receiving, when a memory access operation of the first type of operation is being handled by the memory system, an indication of an interrupt to be taken, determining whether the memory access operation has reached a stage for which a remaining time to complete the memory access operation will be bounded;
responsive to the remaining time to complete the memory access operation being bounded, stalling the interrupt until the memory access operation has completed; and
responsive to the remaining time to complete the memory access operation being unbounded, aborting the memory access operation and allowing the interrupt to be taken.

17. A non-transitory computer-readable medium to store computer-readable code for fabrication of an apparatus comprising:
processing circuitry to execute instructions;
a memory system to store data and provide access to the data in response to memory access operations from the processing circuitry, wherein the memory system is operable in response to a first type of memory access operation for which:
a time taken to handle the memory access operation is unbounded,
the memory access operation is able to change contents of data stored in the memory system, and
a response is required from the memory system in respect of the memory access operation; and
memory access operation handling circuitry responsive to receiving, when a memory access operation of the first type of memory access operation is being handled by the memory system, an indication of an interrupt to be taken, to determine whether the memory access operation has reached a stage for which a remaining time to complete the memory access operation will be bounded;
wherein the memory access operation handling circuitry is responsive:
to the remaining time to complete the memory access operation being bounded, to stall the interrupt until the memory access operation has completed; and
to the remaining time to complete the memory access operation being unbounded, to abort the memory access operation and allow the interrupt to be taken.
